(19) United States
(12) Patent Application Publication
(10) Pub. No.: US 2014/0159658 A1
(43) Pub. Date: Jun. 12, 2014

(54) Random Restart Apparatus and Method for Electric Vehicle Service Equipment

(71) Applicant: AEROVIRONMENT, INC., Monrovia, CA (US)

(72) Inventors: Taras Kiceniuk, JR., Santa Paula, CA (US); Ming Bai, Porter Ranch, CA (US); Albert Joseph Flack, Lake Arrowhead, CA (US)

(73) Assignee: AEROVIRONMENT, INC., Monrovia, CA (US)

(21) Appl. No.: 13/902,557

(22) Filed: May 24, 2013

Related U.S. Application Data
(63) Continuation of application No. PCT/US11/61529, filed on Nov. 18, 2011.
(60) Provisional application No. 61/417,078, filed on Nov. 24, 2010.

(51) Int. Cl. B60L 11/18

(52) U.S. Cl. CPC B60L 11/1816
USPC 320/109; 320/155

(57) ABSTRACT

An electric vehicle (EV) charger restart method includes determining a respective restart delay time (T_{del}) for each of one or more electric vehicle chargers, each respective restart delay time (T_{del}) comprising a respective delay time increment based on a generated random number and a group time interval for reset (Tᵢₙₜ) (block 212), and initiating a restart of at least one of the one or more electric vehicle chargers, if an existing time (T_{now}) is greater than an established time line start time (T_{POK}) plus T_{del}.

### CROSS-REFERENCE TO RELATED APPLICATIONS

This application claims priority to and benefit of Provisional Patent Application No. 61/417,078 filed Nov. 24, 2010, the contents of which are hereby incorporated by reference herein for all purposes.

### TECHNICAL FIELD

This invention relates to electric charging systems, and more particularly to electric vehicle chargers drawing power from an electrical grid.

### BACKGROUND ART

The introduction of electric vehicles to the nation's highways is forecast to place additional electrical demands on the local power grids as the electric vehicles are connected to recharge. A need exists to reduce the instantaneous load on the electric grid from individual and groups of electric vehicle chargers during times of increased electrical grid demand.

### DISCLOSURE OF THE INVENTION

Embodiments include methods and devices for restarting one or more electric vehicle chargers based on a delayed startup time, where the delayed startup time of each charger unit is based on a randomly generated number. One embodiment of an electric vehicle (EV) charger restart method includes determining a respective restart delay time (T_{del}) for each of one or more electric vehicle chargers, each respective restart delay time (T_{del}) comprising a respective delay time increment based on a generated random number and a group time interval for reset (Tᵢₙₜ), determining if the determined respective restart delay time (T_{del}) is met, and initiating a restart of at least one of the one or more electric vehicle chargers, if the determined restart delay time (T_{del}) is met. In such an embodiment, the method may also include determining a difference between a measured source voltage and a normal source voltage at at least one of the one or more electric vehicle chargers and, if the determined difference between the measured source voltage and the normal source voltage is within a threshold, then setting an established time line start time (T_{POK}) for the at least one electric vehicle charger. The step of initiating a restart may begin at or after a time equal to T_{POK} plus T_{del}, and the respective restart delay time (T_{del}) may further comprise a predetermined time grid stabilization delay (Tᵢₙₜ₂). If the determined difference between the measured source voltage and the normal source voltage is not within a threshold, the method may include performing the determining a difference between a measured source voltage and a normal source voltage step again after a predetermined delay (DT1).

In embodiments where the respective restart delay time (T_{del}) further comprises a predetermined time grid stabilization delay (Tᵢₙₜ₂) Tᵢₙₜ₂ may be between 20-60 seconds. T_{del} may also be between 25-60 seconds. The group time interval for reset (Tᵢₙₜ) may be between 5 and 20 seconds, and the generated random number may be between zero and one. The generated random number function may include an exponent (m) greater than 1.

Embodiments of the method may also include monitoring a difference between a reference phasor value and at least one PMU feedback signal indicative of a power grid phasor value, and if the difference is within a threshold (f), then setting an established time line start time (T_{POK}) for the at least one electric vehicle charger.

Alternative embodiments include receiving a power grid health signal from a power grid control processing unit in the at least one electric vehicle charger, setting an established time line start time (T_{POK}) for the at least one electric vehicle charger in response to receipt of the power grid health signal, and wherein the initiating a restart begins at or after a time equal to T_{POK} plus T_{del}. In such configurations, the respective restart delay time (T_{del}) may further include a predetermined time grid stabilization delay (Tᵢₙₜ₂), and Tᵢₙₜ₂ may be between 20-40 seconds. T_{del} may be between 25-60 seconds. The generated random number may be between zero and one, and the generated random number may include an exponent (m) greater than 1.

The method may also include providing a pulse width modulated EVSE pilot signal to an electric vehicle, the pulse width modulated EVSE pilot signal over-riding an on-board charger current loading ramp function to extend the electric vehicle's power ramp time.

In one embodiment of a device including a processing module for restarting one or more electric vehicle chargers, wherein the processing module comprises a processor having addressable memory, the processor may configured to:

(i) determine if grid power quality is acceptable;

(ii) set an established time line start time (T_{POK}) for the at least one electric vehicle charger in response to determining grid power quality is acceptable;

(iii) determine a respective restart delay time (T_{del}) for each of one or more electric vehicle chargers, the respective restart delay time (T_{del}) comprising a delay time increment based on a respective generated random number function and a group time interval for reset (Tᵢₙₜ); and

(iv) initiate a restart of at least one of the one or more electric vehicle chargers, if a current time (T_{now}) is greater than T_{del} plus T_{POK}. In such an embodiment, the respective restart delay time (T_{del}) may include a predetermined time grid stabilization delay (Tᵢₙₜ₂). The generated random number function may further include an exponent (m) greater than 1.

In an alternative embodiment of a method, the method may include receiving in an electric vehicle (EV) charger a PMU power quality signal, determining a difference between the PMU power quality signal and a reference PMU power quality signal, and if the determined difference between the PMU power quality signal and a reference PMU power quality signal is within a threshold, then setting an established time line start time (T_{POK}) for the at least one electric vehicle charger, determining a respective restart delay time (T_{del}) for the EV charger, the restart delay time (T_{del}) comprising a respective delay time increment based on a generated random number and a group time interval for reset (Tᵢₙₜ), and initiating a restart of the EV charger if an existing time (T_{now}) is greater than T_{POK} plus T_{del} The PMU power quality signal may be indicative of a measured power grid phasor. The restart delay time (T_{del}) may include a predetermined time grid stabilization delay (Tᵢₙₜ₂), and

Tᵢₙₜ₂ may be between 20-60 seconds. In such an embodiment, T_{del} may be between 25-60 seconds. The generated random number function may include an exponent (m) greater than 1.

### BRIEF DESCRIPTION OF DRAWINGS

Embodiments are illustrated by way of example and not limitation in the figures of the accompanying drawing, and in which:

FIG. 1 is a block diagram of one embodiment of an electric vehicle charger that is configured to provide a restart delay time (T_{del}) based on a generated random number;

FIG. 2 is a flow chart illustrating one embodiment of a method for initiating a restart of an electric vehicle charger;

FIG. 3 is a block diagram of a power grid control system that has, in one embodiment, electric vehicles coupled to electric vehicle charger configured to provide a restart delay time (T_{del}) based on a generated random number;

FIG. 4 is a block diagram illustrating an electric vehicle supply equipment (EVSE) unit connected to a utility power grid, configured to provide a restart delay time (T_{del}) based on a generated random number and connected to charge an electric vehicle;

FIG. 5 is a graph illustrating pulse width versus EVSE restart process time to extend an on-board charger current loading ramp function;

FIG. 6 depicts an EVSE unit of one embodiment of an electric vehicle charger that is mounted on a support structure; and

FIG. 7 is a block diagram of the EVSE illustrated in FIG. 5, the EVSE wired to a 240 VAC power line.

### BEST MODES FOR CARRYING OUT THE INVENTION

Embodiments are described of an electric vehicle charging system that has a restart processor configured to mitigate the effects of individual and groups of electric vehicle (EV) chargers restarting, such as occurs subsequent to interruption in power service. The electric vehicle charging system may determine a respective restart delay time (T_{del}) for each of one or more EV chargers, the respective restart delay time (T_{del}) comprising a respective delay time increment based on a generated random number and a group time interval for reset (Tᵢₙₜ). The system may establish a time line start time (T_{POK}) based on comparison of reference and received PMU power quality signals, such as phasor current or phasor voltage values, and may initiate a restart of one or more of the EV chargers if an existing time (T_{now}) is greater than T_{POK} plus T_{del}.

More particularly, EV chargers, alternatively called “charging stations,” frequently have storage capacitors that result in a high power demand when each device is powering up. When connected in multiples of ten or one hundred, EV chargers may collectively present a sufficiently large load on the power grid to make reestablishing power service difficult. If the power outage is locally confined, e.g., due to a circuit breaker interruption, then the grid should have ample reserve to handle the startups. However, if the start-up requirements of the EV chargers on the re-powered circuit are extreme, for instance if all the chargers restart at once, then the local circuit breaker may blow, or open, due to high current demand.

Notably the restart power surge problem may be divided into two categories: restart after over-demand grid failure, and local restart after circuit interruption. To prevent overloading of the grid during the simultaneous start-up of multiple EV chargers, each EV charger may be configured to restart at a random time within a time interval, e.g., after a power outage, or after a power grid malfunction, and in so doing lower the probability that multiple EV chargers will startup simultaneously, or substantially simultaneously, and overload the grid. This random restart capacity is especially advantageous during periods of peak power demand when unpredictable loads serve to increase the instability of the power distribution network. Accordingly, to attenuate the injection of transient voltage drops into the grid, embodiments cause the effected EV chargers to power on at a restart delay time that has a delay time increment based on a generated random number.

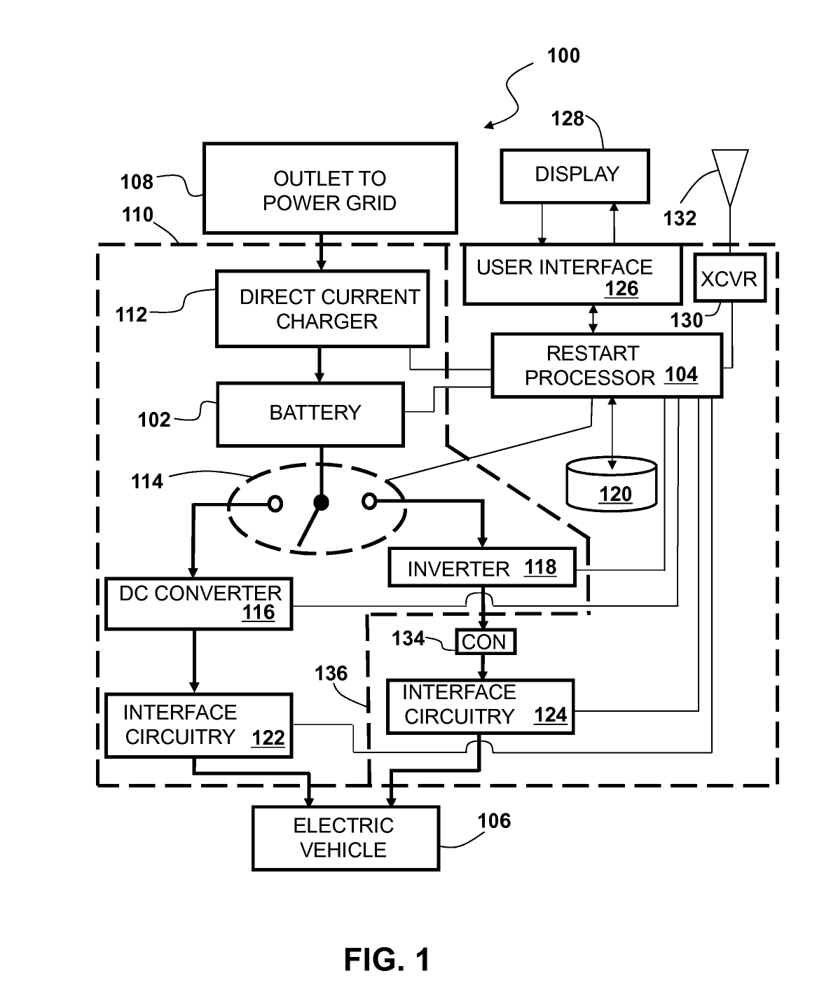

FIG. 1 depicts an exemplary functional block diagram of an EV charger 100 that is configured with a restart processor for mitigating the effects of individual and groups of EV chargers restarting subsequent to interruption in power service. The EV charger may have a restart processor 104 that may be configured to provide one or more features such as: determining a restart delay time based on a generated random number, initiating restart of the charger, determining a difference between measured source voltage and normal source voltage, monitoring a difference between at least one PMU feedback signal indicative of a power grid health (a local or regional PMU phasor measurement indication) and a reference power grid health value, and monitoring a difference between at least one PMU feedback signal indicative of power grid conditions and a reference power grid condition value. The EV charger may have a battery store 102 to store energy, and may output direct current or alternating current for an electric vehicle 106. Accordingly, the exemplary general system shown 100 includes a connection to the power grid 108 to transmit power to and from the grid, and an electric vehicle 106 receiving level 2 or level 3 (direct current charging) from an exemplary device 110 or charging system. A direct current charger 112 is shown interposed between the power grid outlet 108 and the battery store 102, or plurality of batteries, for converting alternating current from the power grid to direct current to charge the battery store 102. An output of the battery store 102 is in communication with a switch 114 for directing the current from the battery store 102 to either a DC converter 116 or an inverter 118. In some embodiments, the switch 114 may be replaced by an electrical splitting module that divides the power to two or more paths.

The restart processor 104 is shown in communication with elements 112, 102, 114, 116, 118, interface circuitry (122, 124) for managing charge of the battery store, obtaining feedback from the battery store, controlling switching of AC/DC charge paths, managing conversion of DC to DC voltages, and managing conversion of DC to AC, respectively, and for managing interface circuitry for AC and DC electric vehicle charging. The restart processor 104 is depicted as in communication with a user interface 126 that may include a display 128, such as a touch-screen display, to enable the user to interact with the restart processor 104. The restart processor 104 is also shown as optionally in communication with a transmitter or a transmitter/receiver element 130, i.e., a transceiver or XCVR that may transmit and receive data via an antenna element 132, such as PMU feedback signals indicative of power grid health (i.e., signals indicative of current and/or voltage phasor values). The exemplary restart processor 104 includes a central processing unit (CPU) and addressable memory 120 where the CPU may be configured via computer-readable instructions to monitor current levels and charge levels within the EV charger and report portions of the monitored values to one or more external communication nodes via the XCVR 130 and antenna 132. The restart processor 104 may be further configured to read data stored in the data store 120, and output the read data to the XCVR 130 for transmitting to a remote site via the antenna 132. The interface circuitry 124 may be an EVSE and may be interposed between the inverter 118 and the electric vehicle 106, and may be detachably connected to the inverter 118 via a connector 134, and the interface circuitry 124, the restart processor 104, memory store 120, user interface 126 and display 128 may comprise a detachable module 136, e.g., a charger, that: (a) may be removed from the device 110 and fixedly attached to a support structure, such as a wall; and (b) wired to an AC power source such as a 220-240 VAC power line. The restart processor 104, user interface 126, display 128, and optional transceiver 130 may be powered via a power supply (not shown) that may receive as input 120 VAC and/or 104 VAC, or may be powered via the direct current charger 112, or other rectifying circuits, and a voltage regulator (not shown). Although described in terms of a “processor,” the restart processor is intended to encompass any manner of logic circuitry or firmware that processes or responds to basic instructions.

During operation, the EV charger restart process may include a restart delay time (T_{del}) that includes a delay time increment based on a generated random number, and may include a predetermined time grid stabilization delay (Tᵢₙₜ₂) to await stabilization or reestablishment of the power grid. Each EV charger may have a processor configured to execute the restart process by generating a random number. The EV charger may base the determination of a time delay between the time when the power from the power grid is reestablished and when the charger initiates restarts based entirely or in part on a locally generated random number. By taking into account the average start up duration of an EV charger, and approximating the toleration of downtime by the user, it is initially estimated that a total time interval of 15 seconds may be sufficient for a small group of EV chargers to restart. Using a conventional RAND( ) function, which, when executed by a digital processors, generates a random number with a uniform probability distribution between zero and one, the restart delay time (T_{del}) for an individual charging station (in seconds) could be thus be determined by:

T_{del}=RAND( )*15 (Eq. 1)

T_{del} would, in this example, have a uniform distribution over 15 seconds, with a mean of 7.5. Accordingly, the entire set of EV chargers collectively executing the EV restart process of the chargers would restart within 15 seconds. Generally, to accommodate various size groups of EV chargers and different power grid supply conditions, the estimated 15 second interval is replaced with the variable Tᵢₙₜ, the desired time interval for a group restart of EV chargers. A value for Tᵢₙₜ can be computed by multiplying the startup interval of an individual charger Tₛₜᵣₜ by the number of chargers and by a redundancy factor of ten or so. For example 15 charger units with 0.1 second startup intervals would then result in a 15 second group interval, this bears a close relationship to equation 3 below.

The program step is then:

T_{del}=RAND( )*Tᵢₙₜ (Eq.2)

Thus all chargers in the group start within the bounds of Tᵢₙₜ, with the restarts distributed with even probability throughout the time interval.

The probability that just one of the chargers in the group is restarting at a particular instant during the restart interval is:

PRB₁=N*Tₛₜᵣₜ/Tᵢₙₜ (Eq. 3)

where Tₛₜᵣₜ is the actual duration it takes for an EV charger to power up.
The probability that two are simultaneously restarting is:

PRB₂=N*(N−1)*(Tₛₜᵣₜ/Tᵢₙₜ)² (Eq.4)

The probability that three are simultaneously restarting is:

PRB₃=N*(N−1)*(N−2)*(Tₛₜᵣₜ/Tᵢₙₜ)³, (Eq. 5)

and so on for an additional number of restarts up to the probability that all N chargers are restarting at once:

PRB_{N}=N!*(Tstrt/Tint)^{N} (Eq. 6)

As is evident by the relationships of values expressed by the above equations, the probabilities are governed by the factor (N*Tₛₜᵣₜ/Tᵢₙₜ). For values of this factor significantly less than one, the probability of simultaneous restarting of multiple units drops rapidly with respect to increasing number of chargers simultaneously restarting. For example, if the maximum tolerability of simultaneous restarts for two chargers is 1% of the restart interval time period, the factor (N*Tₛₜᵣₜ/Tᵢₙₜ) should be less than one-tenth, i.e., less than 0.1. This is because the probability that two chargers are simultaneously restarting is roughly equal to the square of the probability that one unit alone is restarting (as long as N is fairly large). For small values of N, equation 4 gives the precise result for the probability of simultaneous restart of two charger units. The probability of three chargers being in restart at once would be approximately 1/10% or 0.001 when continuing this example. It is also important to consider that the chargers often go into a standby state after restart, whereby being in a standby state may include: waiting to be used to charge an electric vehicle, or hooked to an electric vehicle that is fully charged. In this standby state mode, after the initial rush of power associated with startup, the charger has very little power demand. When in the active “in use” mode a charger has a significant power demand after startup, which affects the local power surplus. The implication then is that the load on the grid from a series of restarting chargers in active use mode is higher at the end of the startup interval, Tᵢₙₜ, (when more chargers are actively charging) than toward the beginning of the startup interval (when many of the chargers are still turned off). In a situation where most of the chargers are in an active mode the algorithm may be optimized by shifting the distribution of startup delay times to concentrate them near the beginning of interval Tᵢₙₜ when the charging demand is relatively low. Accordingly, the determination of the time delay may be based on:

T_{del}=(RAND( ))^{m}*Tᵢₙₜ (Eq. 7)

where the exponent, m, is a number>1. For example when m=2 the median value of the restart delay intervals, T_{del}, would be 0.25*Tᵢₙₜ.

Selection of a value for the exponential factor (m) can be based on the ratio of the power necessary to start the charger, Pₛₜₐᵣₜ, to the power required to operate it during normal active use P_{charge}, e.g., (Pₛₜₐᵣₜ/P_{charge}), and on the minimum steady reserve capacity of the system, i.e., a steady reserve capacity, Pᵣₑₛ, may be defined as the difference between the available power supply, P_{supply}, and the power consumed by the actively in use charging stations, P_{charge}, e.g.,

Pᵣₑₛ=P_{supply}−Nc*P_{charge} (Eq. 8)

Where Nc is the number of units actively charging.

The preceding relationships for determining a time delay for the EV restart process consider the group EV charger circuit in isolation from wider power demand issues. This presumption may be applicable in the case where the circuit breaker that serves only the group of EV chargers is cycled, i.e., where the circuit breaker is turned off then on again. Although occurring less frequently than a circuit interruption, the restart difficulties after a general power outage may be much more significant, as the power supply may be marginal for about the first twenty seconds or longer, after power is restored and while a wide variety of devices start up again throughout the grid network. Accordingly, the relationship for determining a time delay for the EV charger restart process may be further refined to accommodate an additional time delay interval Tᵢₙₜ₂ with the intent to ensure that the chargers may power on after the grid has had a sufficient time to stabilize: a satisfactory value for Tᵢₙₜ₂ is estimated to be around thirty seconds, but a more accurate value can be obtained from local grid parameters and experience. The charger may receive information regarding the nature of the power outage and adjust the value of Tᵢₙₜ₂ accordingly.

The relationship for determining a restart delay time T_{del} for an individual EV charger restart may be expressed as:

T_{del}=Tᵢₙₜ₂+(RAND( ))^{m}*Tᵢₙₜ. (Eq. 9)

In the preceding examples, the values for Tᵢₙₜ and Tᵢₙₜ₂ are estimated, and may be specified before initiation of restart for any particular EV charger. Other embodiments may determine the time delay intervals based on the conditions at a particular EV charging station. For example, Tᵢₙₜ may be determined from a function based on the difference between the normal supply voltage, Vₙₒᵣₘ, and the measured supply voltage; Vₘₑₐₛ:

Tᵢₙₜ=(Vₙₒᵣₘ−Vₘₑₐₛ)^{e1}*c1 (Eq. 10)

Tᵢₙₜ₂=(Vₙₒᵣₘ−Vₘₑₐₛ)^{e2}*c2+c3, (Eq. 11)

where c1, c2 and c3 are characteristic time calculating factors specific to the charger and e1 and e2 are exponents greater than one. If a desired threshold voltage must be reached before the charger is restarted, the process may include additional criteria, such as the critical cutoff voltage difference, k, where the startup procedure is only initiated if Vₙₒᵣₘ−Vₘₑₐₛ is less than k, where Vₙₒᵣₘ is the nominal power grid voltage and Vₘₑₐₛ is the measured power grid voltage. Accordingly, the limiting factor k helps to ensure that the charger is only restarted when the grid is ready to assume greater loads. It will be evident to those skilled in the art that more complex functions can be employed for determining suitable values of the delay intervals, and that computer-implemented methods using these more complex algorithms fall within the scope of this invention.

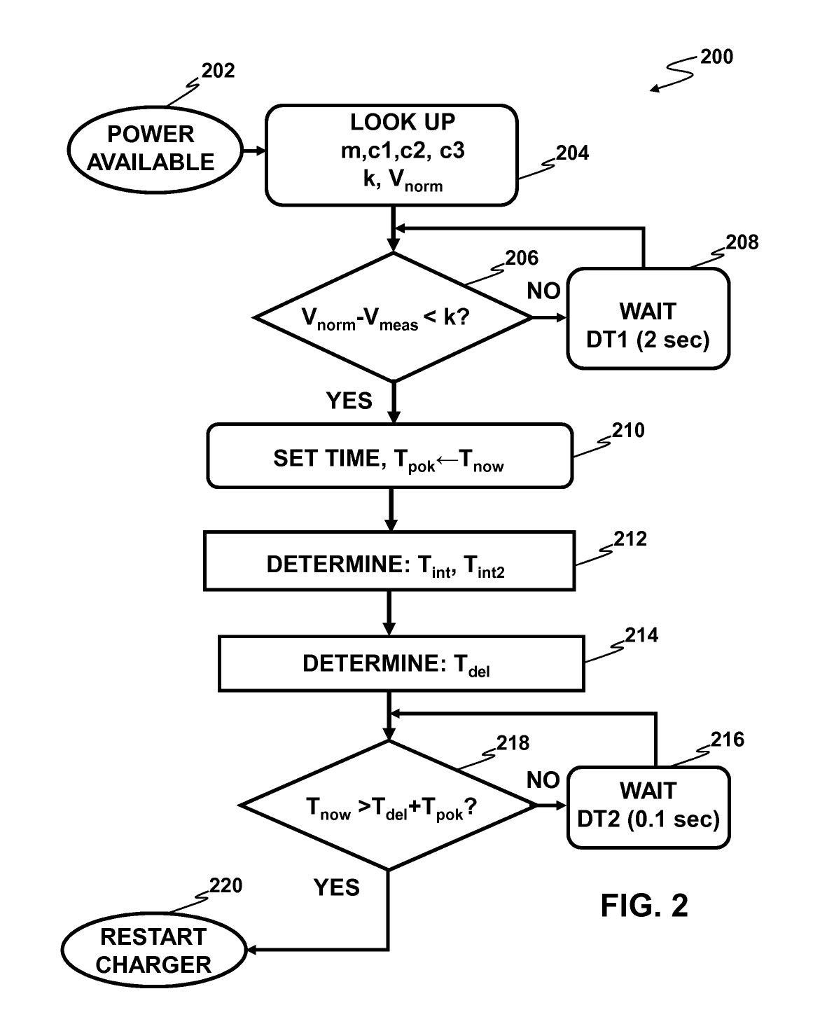

An exemplary process 200 is depicted in the flowchart of FIG. 2. An EV charger detects power from the power grid is available (test 202). The process may extract from memory values such as m, c1, c2, c3, e1, e2, k, and Vₙₒᵣₘ (block 204). The first test pertains to grid health. In one embodiment, a difference is determined between a measured source voltage and a normal source voltage at one or more electric vehicle chargers and if the difference of this power grid health signal indication is within a predetermined threshold (e.g. (Vₙₒᵣₘ−Vₘₑₐₛ)<k) (test 206), the start sequence may be initiated. If the difference is over or equal to the grid test threshold k, the start sequence is not initiated and the test is performed again after a delay, DT1, where DT1 is, in one embodiment, approximately two seconds (block 208). If the grid test threshold k is met (e.g., (Vₙₒᵣₘ−Vₘₑₐₛ)<k), preferably for a sufficient amount of time (approximately 10 test cycles or 20 seconds, depending on the local situation), then a provisional time line may be established with Tₚₒₖ assigned the current clock time (block 210) of T_{now}. Time delay interval Tᵢₙₜ, and time delay interval Tᵢₙₜ₂, may be determined (block 212), or their respective determinations may be incorporated into the determination of T_{del} (block 214) (as in equation 9, above). The determined restart time delay may be added to the established time line start time, Tₚₒₖ, and with periodic testing, e.g., approximately every tenth of a second (block 216) (DT2=0.1 second), once the present clock time of T_{now} exceeds the sum of the start time (test 218), Tₚₒₖ, and the determined delay time, T_{del}, then the EV charger processor may initiate the EV charger startup process (block 220). i.e.,:

T_{now}>Tₚₒₖ+T_{del} (Eq. 12)

The EV restart process may comprise an exponential term, (RAND( ))^{m}, which facilitates more immediate restarting of the chargers—to take advantage of the increased availability of reserve power as the individual charging systems initially start to come back on line. The EV restart process may include a hedge against grid instability and the marginal power supply at the end of a total outage, and more particularly may include an ancillary time delay Tᵢₙₜ₂. The EV restart process may be positioned to restart EV chargers so as to balance between when the grid is available and when the EV chargers require the most power transmittance, and so the EV restart process may be applied in the EV chargers of power networks governed by utilities, i.e., networks that must provide reliable service while minimizing load perturbations or spikes.

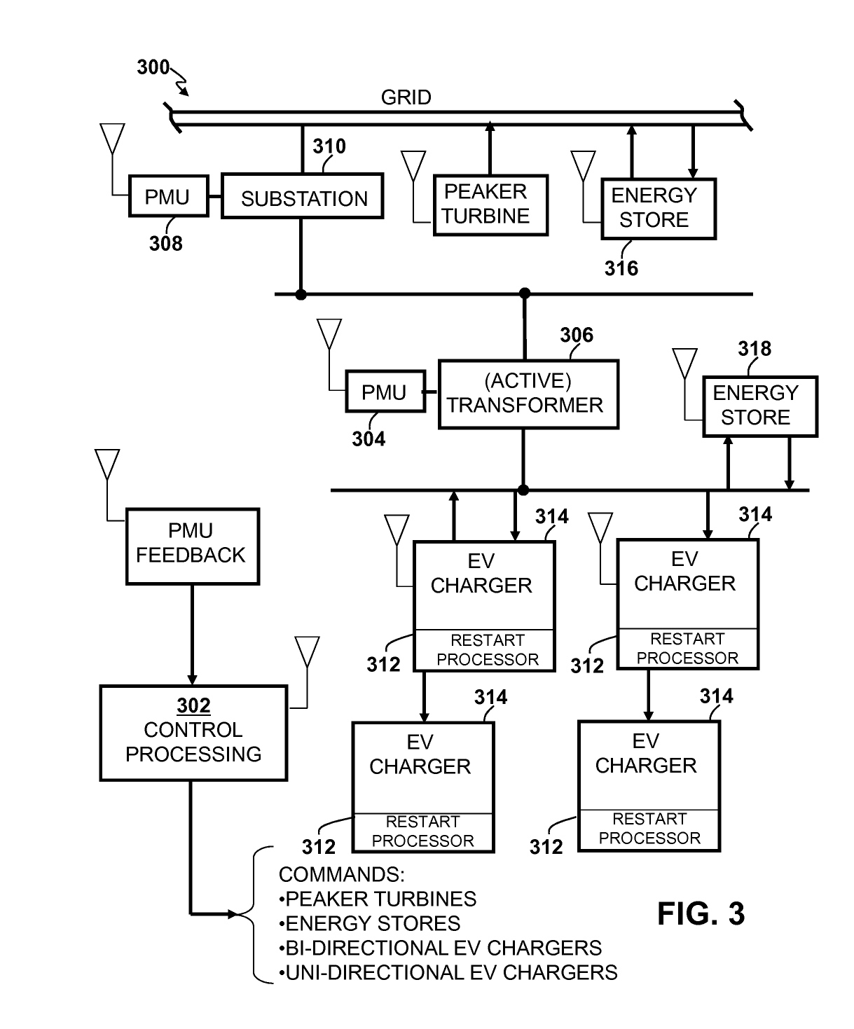

FIG. 3 depicts a top-level system block diagram where a power grid control system 300 comprises a control processing unit 302 that has a processor and addressable memory, where the control processing unit 302 is configured to receive feedback signals from phasor measurement units (PMUs) 304 of active transformers 306 of a utility power grid, and feedback signals from PMUs 308 of power grid substations 310. The control processing unit 302 may be configured to provide a PMU power quality signal to each restart processor 312 in each EV charger 314. In one embodiment, the grid health test described above in steps 204, 206 and 208 of FIG. 2 may be replaced with evaluation by the restart processor of the PMU power quality signal received from the control processing unit 302. Where the PMU quality signal represents a comparison of PMU phasor measurements to a reference phasor measurement, or to a comparison of a local measured PMU phasor measurement to the reference phasor measurement, the health test for each EV charger 314 may be based on a difference between a power grid reference phasor value and at least one PMU feedback signal received from the control processing unit 302. If the difference between measured and reference power grid phasor values is over or equal to the grid test threshold f, the start sequence is not initiated and the test is performed again after a delay DT1 that may be approximately two seconds. (See FIG. 2, block 208.) If the grid test threshold f is met (i.e., (freqₙₒᵣₘ−freq_{PMU})<f), preferably for a sufficient amount of time (approximately 10 test cycles or 20 seconds, depending on the local situation), then a provisional time line may be established with Tₚₒₖ assigned the current clock time (See FIG. 2, block 210) of T_{now}. Rather than each restart processor monitoring for the PMU feedback signal, the health test may be applied at the control processing unit 302 itself, with a successful grid test threshold f test resulting in a SET TIME to Tₚₒₖ (See FIG. 2, block 210) command being sent to each EV charger for initiation of EV charger startup.

In one embodiment, the control processing unit 302 may be configured to provide an EV charger start-up signal to a restart processor 312 in each EV charger 314 subsequent to interruption in power grid service. The control processing unit 302 may be further configured to provide control signals to grid-level energy stores 316, 318 each being configured, responsive to a control signal from the control processing unit 302, to draw power from, and provide power to, the power grid.

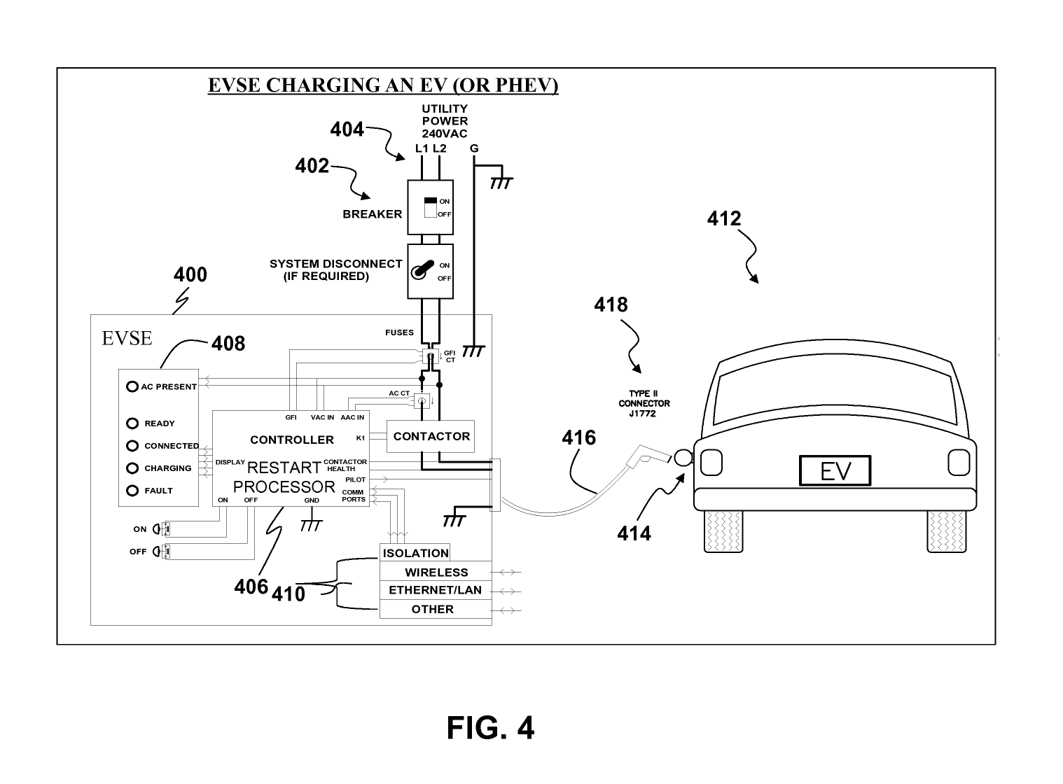

FIG. 4 is an exemplary embodiment of an electric vehicle supply equipment (EVSE) unit charging an electric vehicle (EV), or plug-in hybrid electric vehicles (PHEV). An EVSE unit 400 is depicted as connected via a breaker 402 to a utility power source 404. The EVSE 400 is depicted as having a microcontroller 406, a status panel 408, and means of interfacing 410 such as wireless, Ethernet, and other means such as a universal serial bus (USB). The EVSE 400 is depicted as connectable to an electric vehicle 412 having a receiving port 414 via a cable 416 having a connector 418 such as a J1772 (type II) connector 418. But, the electric vehicle may provide the charging cable from the vehicle to a commercial charging station. The commercial charging station, particularly a commercial charging station that does not have a charging cable, may have a cable receiver with an interlocking mechanism.

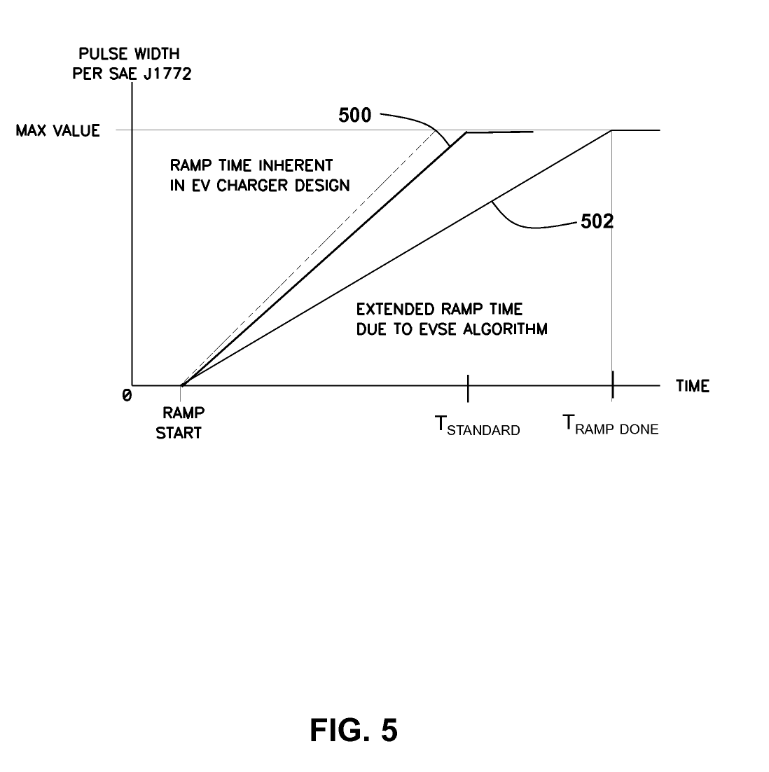

The EVSE 400 may provide an EVSE pilot signal to the electric vehicle 412 to establish current draw from near zero current up to the pre-determined maximum current draw using a current ramp function to ease EV restart loading of the utility power source 404. However, instead of using an EV-defined current ramp profile, the restart processor 406 may enable the EVSE 400 to override and extend the ramp-up time for the EV current draw to mitigate the effects of individual and groups of EV chargers restarting, such as occurs subsequent to interruption in power service (See FIG. 5).

FIG. 5 is a graph of one embodiment of a EVSE pilot signal profile illustrating pulse width verses EVSE restart process time to override and extend an on-board charger current loading ramp function from what would otherwise be defined by the EV. For a particular EV on-board charger design, the EVSE standard ramp 500 depicts a EVSE pilot signal profile that achieves maximum current draw by the EV at time T_{STANDARD}. In one embodiment, the restart processor overrides and extends the EVSE pilot signal profile to a modified T_{RAMP DONE} time, as illustrated by extended ramp line 502, to provide a current ramp up that takes longer to complete than T_{STANDARD}. For example, for an EV with a built-in fixed current ramp completing in 15 seconds, the EVSE may ramp up the current limit indication to the EV via the EVSE pilot signal to over 2-3 minutes to slow down the EV restart loading even farther, giving the utility more time to react to what could be very many such loads coming on from other EVSE units. As the EVSE pilot signal profile becomes more gradual to extend the current ramp time, the optimal randomizing exponent value (See Equations 7 and 9) may move closer to one. In another embodiment, the EVSE monitors utility signals from the control processing unit 302 (See FIG. 3) to “throttle” the EVSE ramp profile in response to utility signals received from the control processing unit to provide further control by the utility.

Although illustrated as linear, the extended ramp line 502 may be non-linear, such as exponential, to weight current draw rate of change toward the end or beginning of the start-up process.

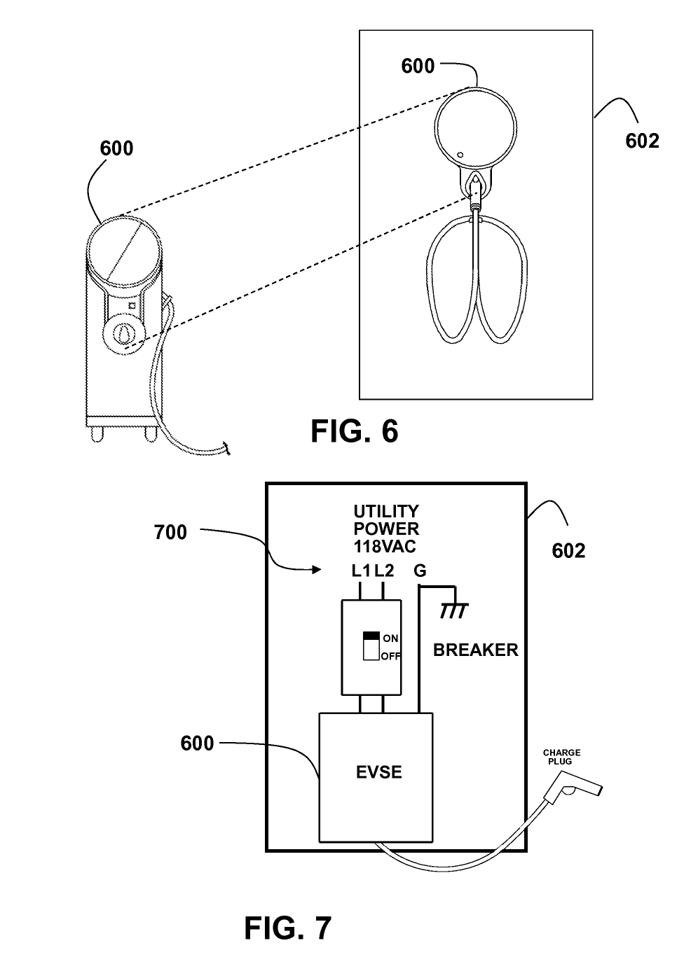

FIG. 6 depicts an EVSE unit of an exemplary EV charging unit 600 of the charging system 110 (See FIG. 1), mounted on a support structure 602. FIG. 7 depicts in a schematic the detachable EVSE 600 of FIG. 2B wired to a 240 VAC power line 700.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further it is intended that the scope of the present invention herein disclosed by way of examples should not be limited by the particular disclosed embodiments described above.

What is claimed is:

1. An electric vehicle (EV) charger restart method, comprising:
determining a respective restart delay time (T_{del}) for each of one or more electric vehicle chargers, each respective restart delay time (T_{del}) comprising a respective delay time increment based on a generated random number and a group time interval for reset (Tᵢₙₜ); and
initiating a restart of at least one of the one or more electric vehicle chargers, if an existing time (T_{now}) is greater than an established time line start time (T_{POK}) plus T_{del}.

2. The method according to claim 1, further comprising:
determining a difference between a measured source voltage and a normal source voltage at at least one of the one or more electric vehicle chargers; and
if the determined difference between the measured source voltage and the normal source voltage is within a threshold, then setting the established time line start time (T_{POK}) for the at least one electric vehicle charger.

3. The method according to claim 2, wherein the respective restart delay time (T_{del}) further comprises a predetermined time grid stabilization delay (Tᵢₙₜ₂).

4. The method according to claim 2, wherein if the determined difference between the measured source voltage and the normal source voltage is not within a threshold, then performing the determining a difference between a measured source voltage and a normal source voltage step again after a predetermined delay (DT1).

5. The method according to claim 1, wherein the respective restart delay time (T_{del}) further comprises a predetermined time grid stabilization delay (Tᵢₙₜ₂).

6. The method according to claim 5, wherein Tᵢₙₜ₂ is between 20-60 seconds.

7. The method according to claim 6, wherein T_{del} is between 25-60 seconds.

8. The method according to claim 1, wherein the group time interval for reset (Tᵢₙₜ) is between five and 20 seconds.

9. The method according to claim 1, wherein the generated random number is between zero and one.

10. The method according to claim 9, wherein the generated random number function further comprises an exponent (m) greater than 1.

11. The method according to claim 1, further comprising:
monitoring a difference between at least one PMU feedback signal indicative of a power grid phasor value and a reference phasor value; and
if the difference between the power grid phasor value and reference phasor value is within a threshold (f), then setting the established time line start time (T_{POK}) for the at least one electric vehicle charger.

12. The method according to claim 1, further comprising:
receiving a power grid health signal from a power grid control processing unit in the at least one electric vehicle charger;
setting the established time line start time (T_{POK}) for the at least one electric vehicle charger in response to receipt of the power grid health signal.

13. The method according to claim 12, wherein the respective restart delay time (T_{del}) further comprises a predetermined time grid stabilization delay (Tᵢₙₜ₂).

14. The method according to claim 13, wherein Tᵢₙₜ₂ is between 20-60 seconds.

15. The method according to claim 14, wherein T_{del} is between 25-60 seconds.

16. The method according to claim 15, wherein the generated random number is between zero and one.

17. The method according to claim 16, wherein the generated random number further employs a function with an exponent (m) greater than 1.

18. The method according to claim 12, wherein the power grid health signal represents a comparison of at least one phasor measurement unit (PMU) phasor measurement to a reference phasor measurement.

19. The method of claim 1, further comprising:
providing a pulse width modulated EVSE pilot signal to an electric vehicle, the pulse width modulated EVSE pilot signal over-riding an on-board charger current loading ramp function to extend the electric vehicle's power ramp time.

20. A device comprising a processing module for restarting one or more electric vehicle chargers, wherein the processing module comprises a processor having addressable memory, and wherein the processor is configured to:
determine if grid power quality is acceptable;
set an established time line start time (T_{POK}) for the at least one electric vehicle charger in response to determining grid power quality is acceptable;
determine a respective restart delay time (T_{del}) for each of one or more electric vehicle chargers, the respective restart delay time (T_{del}) comprising a delay time increment based on a respective generated random number function and a group time interval for reset (Tᵢₙₜ); and
initiate a restart of at least one of the one or more electric vehicle chargers, if a current time (T_{now}) is greater than T_{del} plus T_{POK}.

21. The device according to claim 20, wherein the respective restart delay time (T_{del}) further comprises a predetermined time grid stabilization delay (Tᵢₙₜ₂).

22. The device according to claim 20, wherein the generated random number function further comprises an exponent (m) greater than 1.

23. A method, comprising:
receiving in an electric vehicle (EV) charger a PMU power quality signal;
determining a difference between the PMU power quality signal and a reference PMU power quality signal;
if the determined difference between the PMU power quality signal and a reference PMU power quality signal is within a threshold, then setting an established time line start time (T_{POK}) for the at least one electric vehicle charger;
determining a respective restart delay time (T_{del}) for the EV charger, the restart delay time (T_{del}) comprising a respective delay time increment based on a generated random number and a group time interval for reset (T); and
initiating a restart of the EV charger if an existing time (T_{now}) is greater than T_{POK} plus T_{del}

24. The method of claim 23, wherein the PMU power quality signal is indicative of a measured power grid phasor.

25. The method of claim 24, wherein the restart delay time (T_{del}) further comprises a predetermined time grid stabilization delay (Tᵢₙₜ₂).

26. The method of claim 25, wherein Tᵢₙₜ₂ is between 20-60 seconds.

27. The method according to claim 26, wherein T_{del} is between 25-60 seconds.

28. The method according to claim 23, wherein the generated random number is produced by a function comprising an exponent (m) greater than 1.
